(19) United States
(12) Patent Application Publication
(10) Pub. No.: US 2018/0181324 A1
(43) Pub. Date: Jun. 28, 2018

(54) DATA PROTECTION WITH ERASURE CODING AND XOR

(71) Applicant: EMC IP Holding Company LLC, Hopkinton, MA (US)

(72) Inventors: Mikhail DANILOV, Saint-Petersburg (RU); Konstantin BUINOV, Kirovsk City (RU); Mikhail MALYGIN, Saint-Petersburg (RU); Ivan TCHOUB, Saint-Petersburg (RU); Maxim S. TRUSOV, Saint-Petersburg (RU)

(21) Appl. No.: 15/634,935

(22) Filed: Jun. 27, 2017

(30) Foreign Application Priority Data
Dec. 26, 2016 (RU) 2016151198

(51) Int. Cl. G06F 3/06

(52) U.S. Cl. CPC G06F 3/0619; G06F 3/0631; G06F 3/067; G06F 3/065; G06F 3/0652

(57) ABSTRACT

Data protection in a distributed storage system is provided using a combination of a data protection operation and an exclusive or XOR operation. Chunks of data subject to replication are encoded with a protection operation and an XOR operation commutative with the protection operation to generate a combined protected data chunk. The protected data chunks from which the combined protected data chunk was generated can be safely deleted to reduce data protection overhead. Portions of the protected data that later become unavailable due to failure in the distributed storage system can be recovered from other portions that are available and the combined protect data chunk using the XOR operation. The protection operation includes a matrix-based erasure coding operation commutative with the XOR operation.

### CROSS REFERENCE TO RELATED APPLICATION

This Application claims the benefit of the earlier filing date of Russian Application No. 2016151198, filed in the Federal Service for Intellectual Property (Rospatent) of the Russian Federation on Dec. 26, 2016, entitled “Data Protection with Erasure Coding and XOR,” the content of which application is incorporated herein by reference in its entirety.

### TECHNICAL FIELD

Embodiments of the present invention relate generally to data storage systems. More particularly, embodiments of the invention relate to data protection for distributed storage systems.

### BACKGROUND

In data storage systems space is allocated for storing a primary set of user data. Additional storage space is allocated for providing data protection for the primary set of data. For example, data protection can include mirroring to generate a backup copy of the primary data. The backup copy provides protection against data loss in the event of primary data failure.

In geographically distributed data storage systems, data protection can include replication to generate copies of primary and backup data and stored independently to provide additional protection.

The amount of additional storage space needed for data protection varies over time. Allocating too much or too little risks data loss, inefficient storage utilization and/or an increase in the cost of storage. Because providing data protection can be costly in terms of storage capacity and processing requirements, large-scale data protection for distributed data storage systems requires complex software architecture and development to achieve outstanding availability, capacity use efficiency, and performance.

The Dell EMC® Elastic Cloud Storage (ECS™) distributed data storage solutions employ data protection methodologies that minimize capacity overhead while providing robust data protection. In case of geographically distributed storage, ECS™ provides additional protection of user data with replication. ECS™ uses exclusive or (XOR) operations to minimize the storage capacity overhead associated with user data replication.

### BRIEF DESCRIPTION OF THE DRAWINGS

Embodiments of the invention are illustrated by way of example and not limitation in the figures of the accompanying drawings in which like references indicate similar elements.

FIG. 1 is a block diagram illustrating an overview of an operating environment of a data protection system according to one embodiment of the invention.

FIGS. 2A-2C are block diagrams illustrating data protection backup with combined data protection operations in further detail according to one embodiment of the invention.

FIGS. 3A-3D are block diagrams illustrating data protection recovery with combined data protection operations in further detail according to one embodiment of the invention.

FIG. 4 is a flow diagram illustrating processes for data protection backup with combined data protection operations according to one embodiment of the invention.

FIG. 5 is a flow diagram illustrating processes for data protection recovery with combined data protection operations according to one embodiment of the invention.

FIG. 6 is a block diagram illustrating a general overview of a data processing system environment for providing a data protection system according to one embodiment of the invention.

FIG. 7 is a block diagram illustrating exemplary erasure coded data used in providing a data protection system according to one embodiment of the invention.

FIG. 8 is a block diagram illustrating exemplary matrix-based erasure coding used in providing a data protection system according to one embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present invention.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

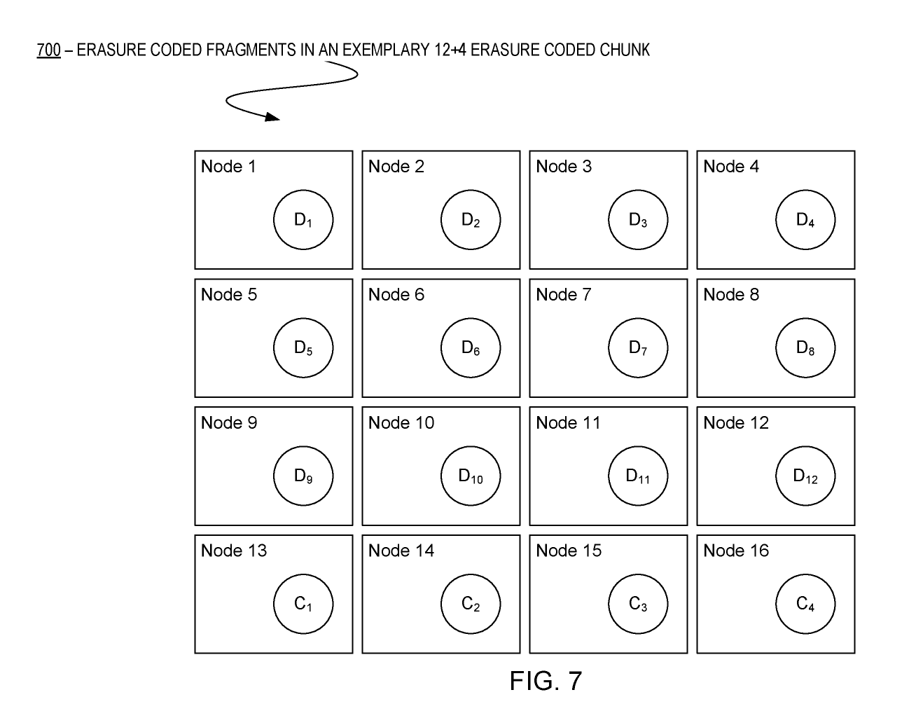

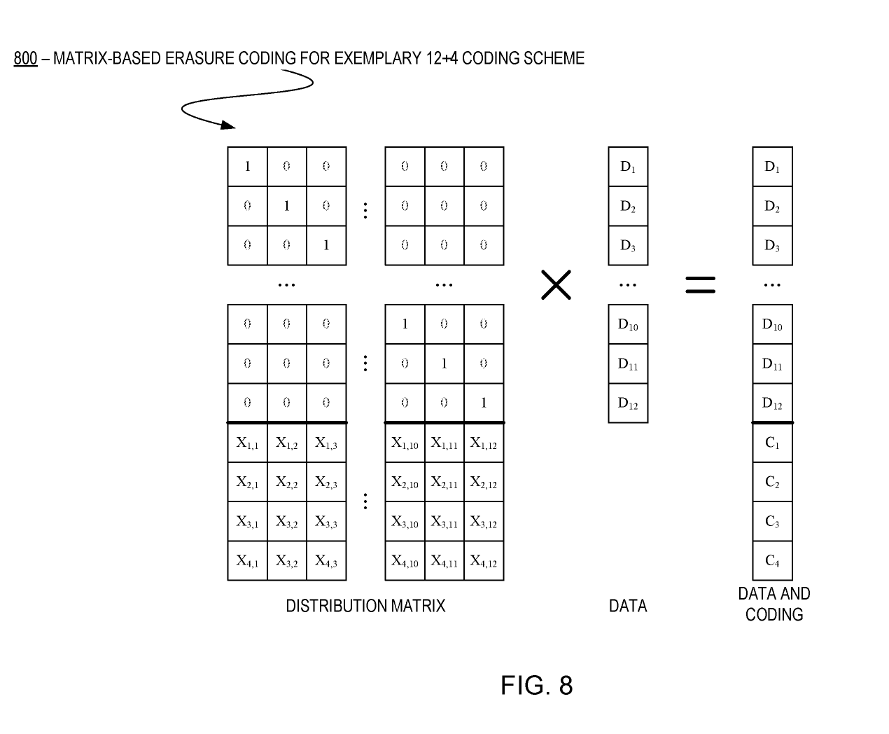

In the description that follows, the following notation is used for ease of illustration. A and B refer to chunks of user data, also referred to as primary data, that are subject to geographically or otherwise distributed data protection replication. X refers to a combined chunk of data generated with exclusive or (XOR) encoding, in this case the XOR combination of A and B. The function e( )refers to an encoding erasure coding function, such as the example erasure coding function described with reference to FIGS. 7-8. A′, B′, and X′ refer to encoded chunks A, B, and X above. Encoded chunks contain corresponding data and coding fragments as described with reference to the erasure coding examples described in FIGS. 7-8.

In conventional replication in a geographically distributed data protection system only data, such as primary data chunks A and B, are transferred between source and target storages/clusters/zones. Protection-aware replication in a geographically distributed data protection system replicates data protection chunks A′ and B′ as opposed to the primary data chunks A and B. So as to not obscure the description of the embodiments of the invention that follows the term replication will be used to generally refer to either replication or protection-aware replication.

In order to carry out replication, a replication target zone protects data using erasure coding and XOR using the following steps (1) through (4):
Step 1: Get A′ and B′ from the source zones.
Step 2: Produce X with the formula X=A 0 B;
Step 3: Produce X′ with the formula X′=e(X);
Step 4: Delete A′ and B′.

Likewise, recovery of an unavailable primary data chunk A that was protected using the above-described erasure coding and XOR must use the following steps (1) through (5):
Step 1: Get B′ from the source zone;
Step 2: Restore A with the formula A=X B;
Step 3: Produce A′ with the formula A′=e(A);
Step 4: Send A′ to the remote zone;
Step 5: Delete A′ and B′.

The challenge presented using the above-described process for protecting and recovering data subject to replication is that it is processing intensive. The source data is already there (A′ and/or B′) but the resulting data (X′ or A′) is generated using two separate data protection operations, namely XOR and erasure coding. While XOR can be efficient, the erasure coding operation is a resource-demanding operation.

To address the challenges of providing additional protection of user data while minimizing the storage capacity overhead associated with replication, the described embodiments of a data protection system provide a resource efficient method for data protection with two data protection operations, erasure coding and XOR.

In one embodiment, the XOR and erasure encoding operations are commutative operations. In other words, the outcome of the combined operations is the same regardless of the order of the operations. The commutative property allows the combined operations to be simplified into a single operation. For example, in one embodiment an XOR operation and a bit-matrix erasure coding operation are commutative as expressed in the following equation:

X′=e(A ⊕ B)=e(A) ⊖ e(B)=A′ ⊕ B′ [EQ. 1]

which can be simplified and rewritten as the following equation:

X′=A′A ⊕ B′ [EQ. 2]

In view of the above observation, the erasure encoding step in the above-described protection and recovery processes, i.e. Step 3, “Produce X′ with the formula X′=e(X)” during protection, and Step 3, “Produce A′ with the formula A′=e(A)” during recovery, can each be eliminated at the expense of an XOR operation on the coding fragments produced for A and B.

From a processing efficiency perspective, the expense of the XOR operation is negligible as compared to the computing intensive erasure coding process. Other advantages are that the additional XOR operation is applied to a lesser amount of data, i.e., the coding fragments only, as opposed to all of the data fragments. Moreover, the XOR operation can be performed in a lightweight byte-by-byte mode, whereas erasure coding requires a volatile memory reservation for all data and coding fragments.

In view of the foregoing, in any one or more of the embodiments of the systems, apparatuses and methods herein described, processes for providing data protection for distributed data storage systems combine commutative data protection operations to minimize the use of system resources, including processor resources, volatile memory, disk and network traffic, and so forth.

In one embodiment, the protected data in the target zone is subject to a XOR operation having a commutative property with a protection operation to generate a combined protected data. In one embodiment, the commutative property enables the use of the XOR operation to reduce the processing overhead associated with data protection by reducing the complexity of the overall protection operation. In particular, the commutative properties of the protection operation and the XOR operation result in a simplified process for combining two or more chunks of protected data into a single combined chunk of protected data than would otherwise be possible.

In one embodiment, the protected data from which the combined protected data was generated can be safely deleted from the target zone because it is no longer necessary for assuring protection. Deleting the unnecessary copies of the protected data from the target zone helps to reduce data protection storage capacity overhead.

In one embodiment, should one or more portions of the deleted protected data, e.g. one or more chunks of deleted protected data, subsequently become unavailable on the other zones/clusters, the target zone can recover the unavailable data from the combined protected data and any one or more of the still available portions of protected data from the other zones/clusters. In that case, performing the XOR operation on the still available protected data and the combined protected data recovers the unavailable portions of the deleted protected data.

In one embodiment, the protection operation is a matrix-based erasure coding operation that is commutative with the exclusive or (XOR) operation. In one embodiment, the protection and XOR operations are performed on blocks of data referred to herein as the aforementioned chunks of data. In one embodiment, the chunks of data can be portions of data storage of a specified size, e.g. 64 MB/128 MB. In one embodiment, the chunks of data belong to a set of blocks of data stored in a partitioned disk space. In one embodiment, the chunks of data include data in any one or more file and object storage formats.

In one embodiment, the distributed data storage system includes a geographically distributed data storage system, including a cloud-based storage system, composed of geographically distributed zones and/or clusters. A zone and/or cluster can include one or more compute nodes and one or more data storage arrays.

In one embodiment, a data protection system enables the creation of redundant backups while minimizing use of data storage space within a distributed data storage system. In one embodiment, the data protection system enables a distributed data storage system to recover data from failure of one or more portions of the distributed data storage system. In other embodiments, the data protection system enables a distributed data storage system to recover data from a failure of one or more nodes in the distributed data storage system.

In one embodiment, the data protection system enables a distributed data storage system to recover data from a failure of a zone and/or cluster in a distributed data storage system. In one embodiment, a zone and/or cluster can communicate with one or more zones and/or clusters in the distributed data storage systems. In one embodiment, a zone and/or cluster can manage and/or store data in chunk format.

In one embodiment, a compute node in a distributed data storage system can include a storage engine. In some embodiments, a storage engine enables communication between one or more compute nodes in a distributed data storage system. In one embodiment, a storage engine enables a distributed data storage system to conduct cluster-wide and/or zone-wide activities, such as creating backups and/or redundancies in a zone. In other embodiments, a storage engine enables a distributed data storage system to conduct system-wide activities that can enable creation of redundancies and/or backups to handle failure of one or more zones and/or clusters while maintaining data integrity across the entire system.

In one embodiment, a storage engine may include one or more layers. In one embodiment, layers within a storage engine may include a transaction layer, index layer, chunk management layer, storage server management layer, partitions record layer, and/or a storage server (Chunk I/O) layer. In one embodiment, a transaction layer parses received object requests from applications within a distributed data storage system. In one embodiment, a transaction layer can read and/or write object data to the distributed data storage system.

In one embodiment, an index layer can map file-name/object ID/data-range to data stored within the distributed data storage system. In various embodiments, an index layer may be enabled to manage secondary indices used to manage data stored on the distributed data storage system.

In one embodiment, a chunk management layer may manage chunk information, such as, but not limited to, location and/or management of chunk metadata. In one embodiment a chunk management layer can execute per chunk operations. In one embodiment, a storage server management layer monitors the storage server and associated disks. In one embodiment, a storage server management layer detects hardware failures and notifies other management services of failures within the distributed data storage system.

In one embodiment, a partitions record layer records an owner node of a partition of a distributed data storage system. In one embodiment, a partitions record layer records metadata of partitions, which may be in a B+tree and journal format. In one embodiment, a storage server layer directs I/O operations to one or more data storage arrays within the distributed data storage system.

In one embodiment, a zone may be enabled to create efficient backups for other zones in a distributed data storage system. In one embodiment, a zone combines backups from multiple zones to create a single backup of combined data that may take the same, or less, space as the backups being combined.

In one embodiment, an XOR operation combines two or more backups into a single backup. In one embodiment, once a combined backup has been created, a distributed data storage system may remove the unneeded uncombined backups.

In one embodiment, a zone and a cluster can equate to the same constructs in a distributed data storage system. In one embodiment, combined XOR data blocks can be created by encoding data from two or more zones. In various embodiments, in a distributed data storage system including N zones (where N>=3), an XOR combined block may include N-1 portions of data from the N zones which can enable more data storage to be conserved as the number of zones increases.

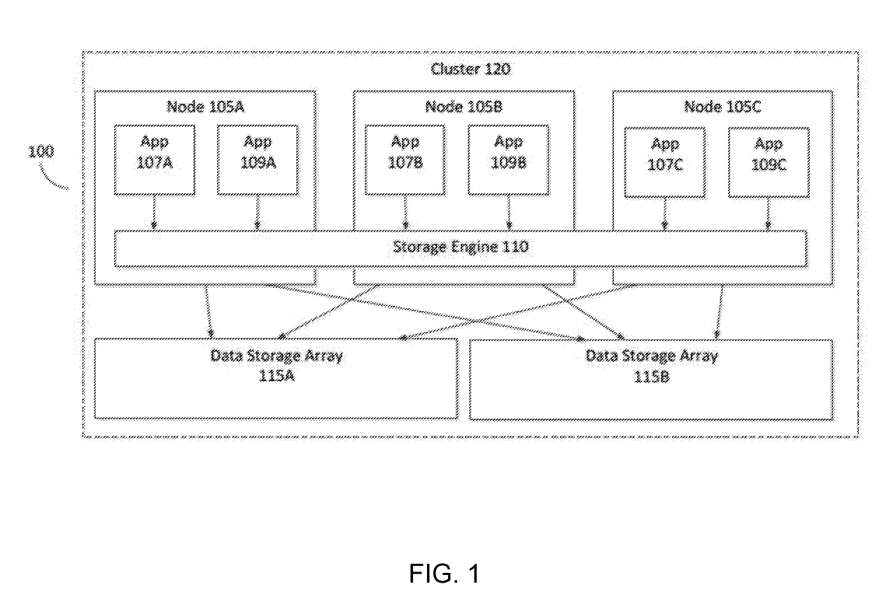

FIG. 1 illustrates an exemplary distributed data storage system in accordance with an embodiment of the present disclosure. As shown, distributed data storage system 100 includes Cluster 120, Nodes (105A-C, 105 generally), and Data Storage Arrays (115A-B, 115 Generally). Node 105A is in communication with Data Storage Array 115A and Data storage Array 115B. Node 105B is in communication with Data Storage Array 115A and 115B. Node 105C is in communication with Data Storage Array 115A and Data storage Array 115B.

In one embodiment, storage engine 110 is executed on each node 105. In one embodiment, storage engine 110 enables Applications 107A, 109A, 107B, 109B, 107C, 109C to execute data I/O requests to and from distributed data storage system 100. In various embodiments, a distributed data storage system may include one or more clusters that may be located in one or more locations.

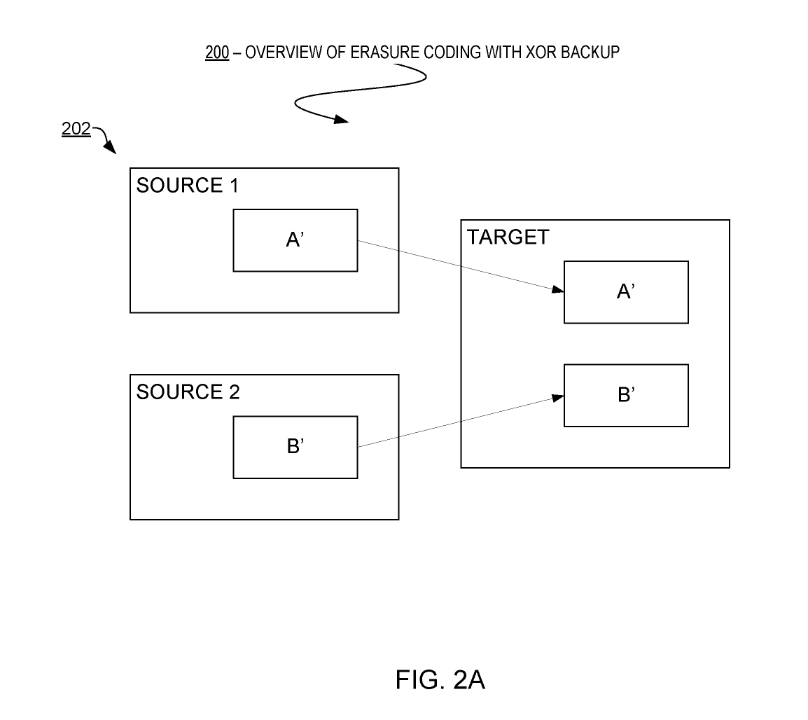

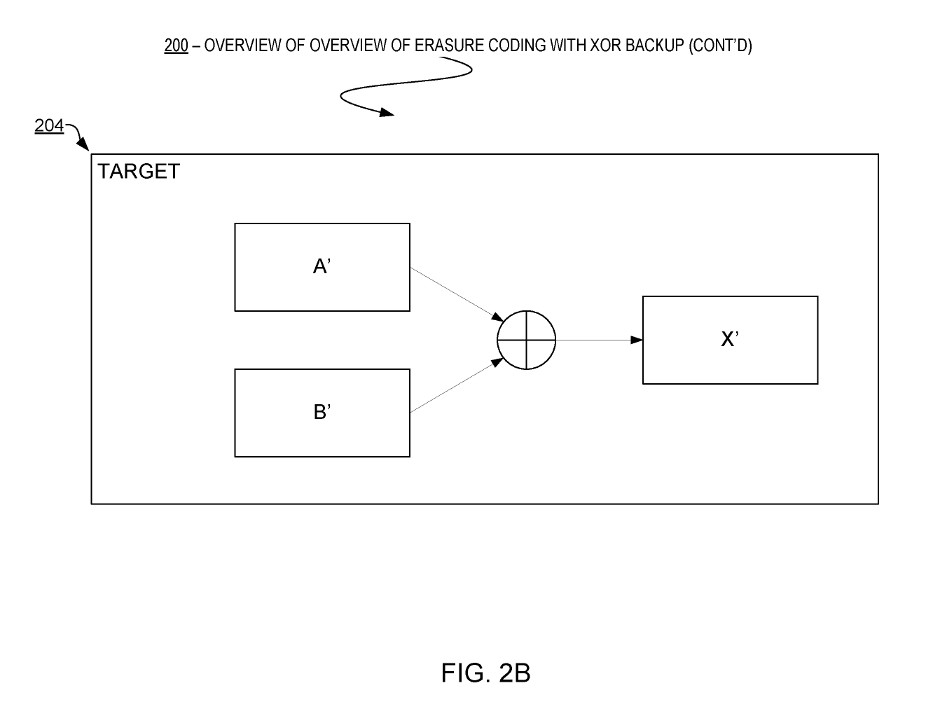

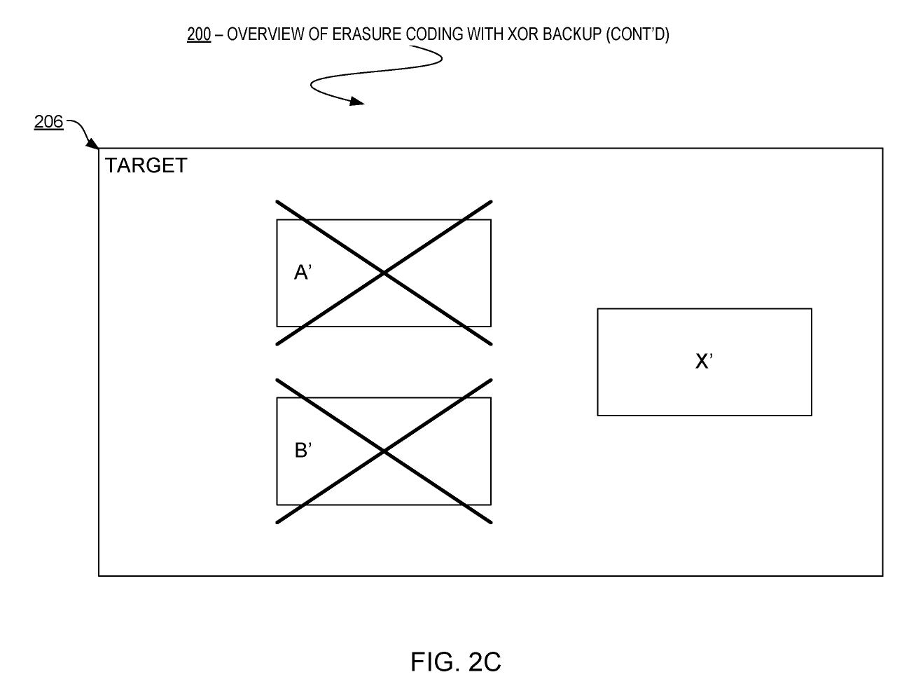

FIGS. 2A-2C are block diagrams illustrating an example of data protection backup with combined data protection operations in further detail according to one embodiment of the invention. In FIG. 2A, in a first process 202, a target zone of a distributed data storage system receives replicated copies of protected data A′ and B′ from their respective source zones, Source 1 and Source 2. In FIG. 2B, in a second process 204, the target zone performs and XOR operation on A′ and B′ to produce X′ as follows:

X′=A′ ⊕ B′ [EQ. 3]

In FIG. 2C, in a third process 206 the protection process concludes by deleting from the target zone the now combined replicated protection data A′ and B′ as they are no longer needed on the target zone for recovery purposes.

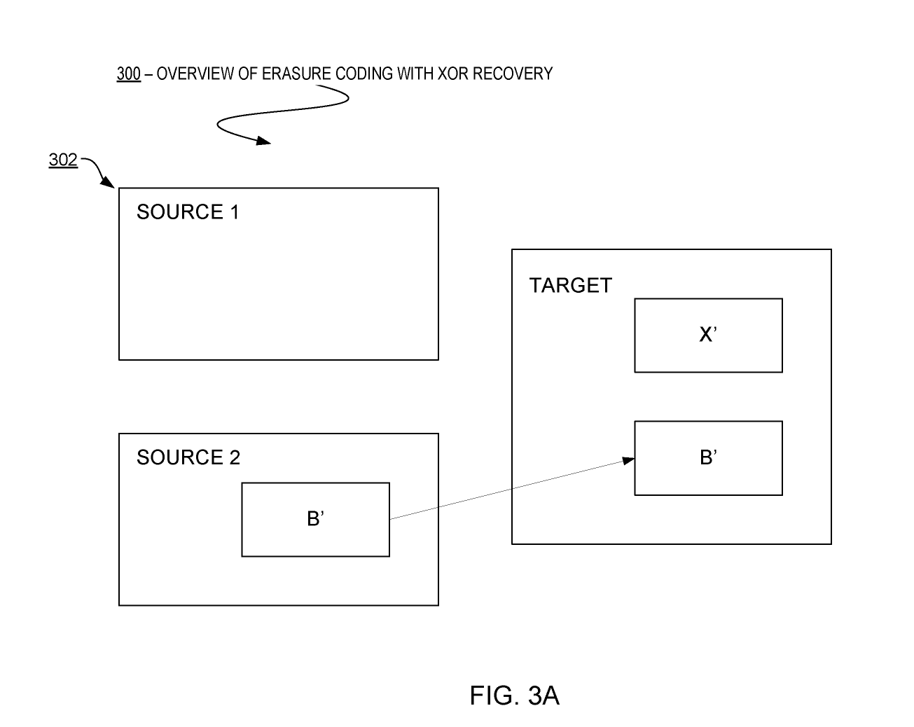

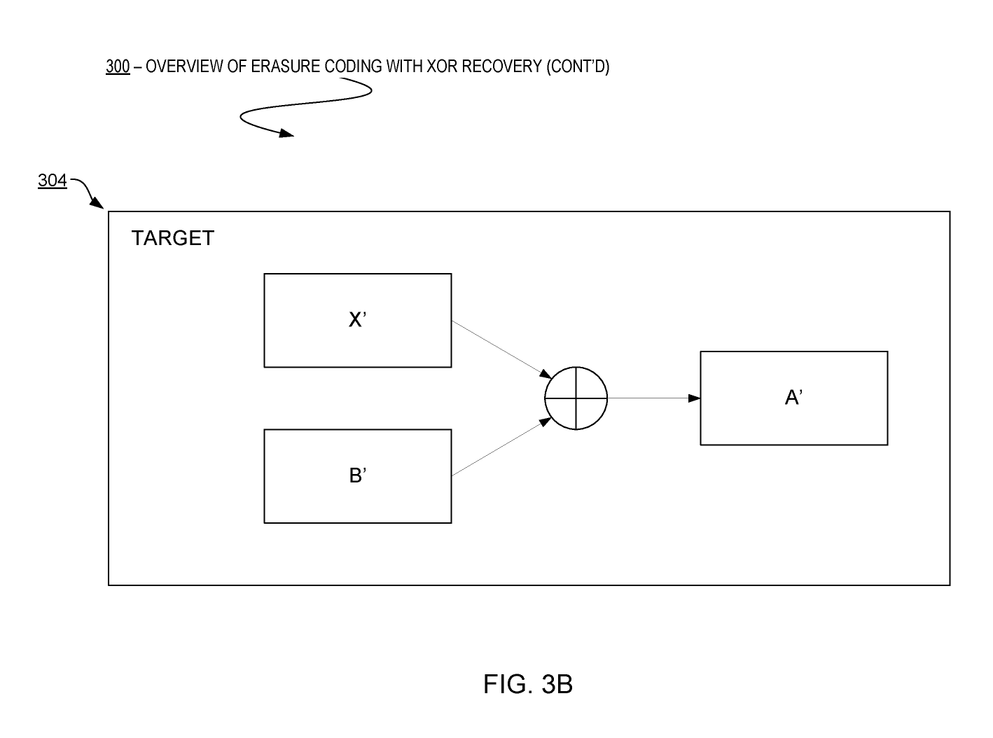

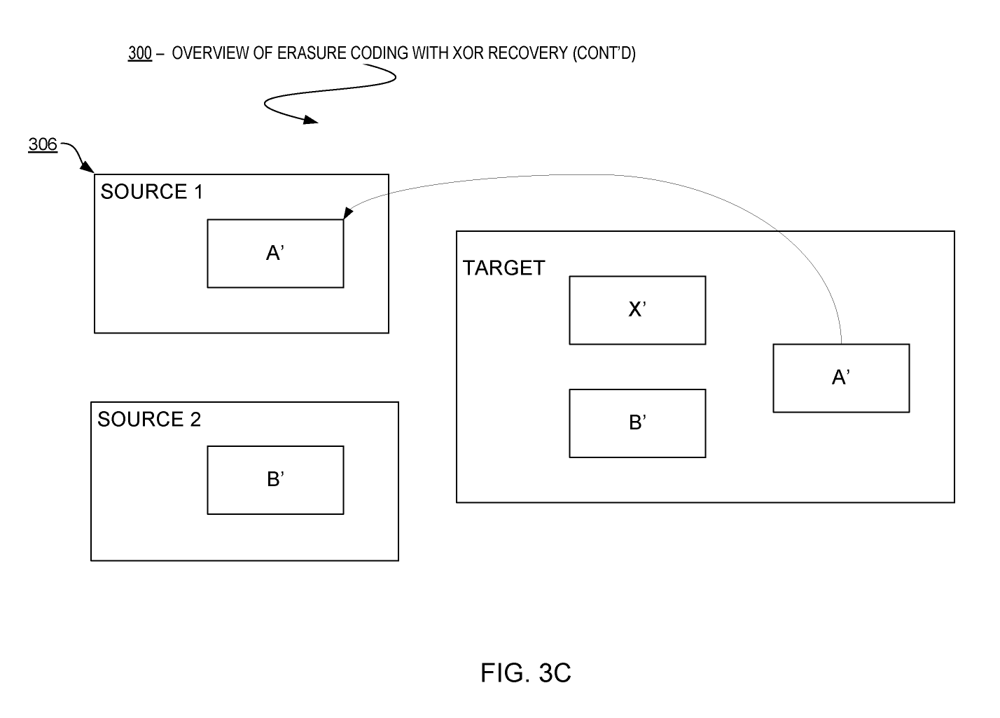

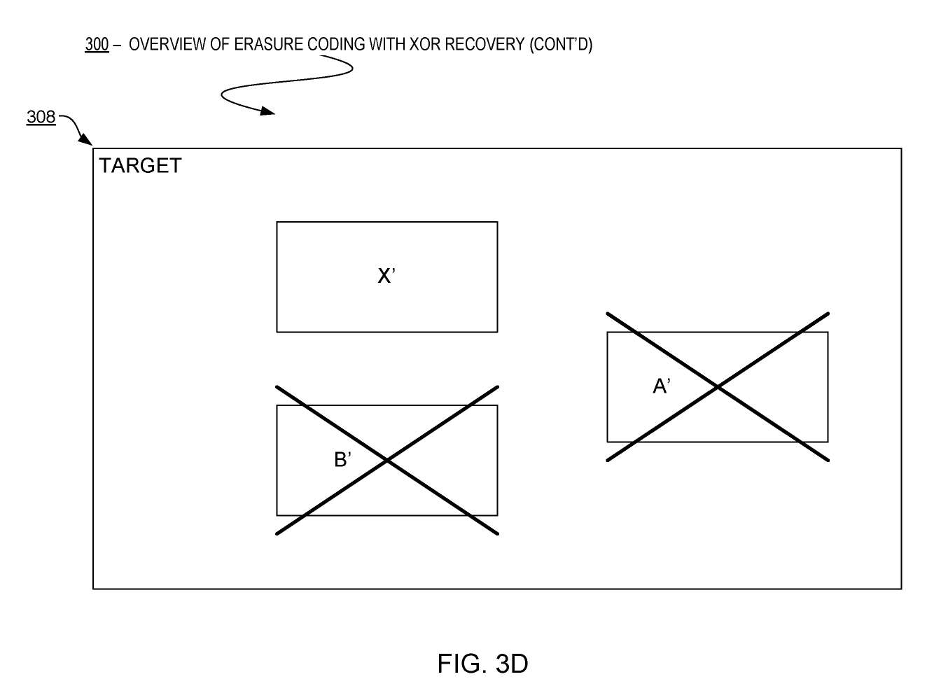

FIGS. 3A-3D are block diagrams illustrating an example of data protection recover with combined data protection operations in further detail according to one embodiment of the invention. In FIG. 3A, in a first process 302, the target zone becomes aware that the data protection data A′ is no longer available in source zone Source 1. Since the target zone is able to recover A′ from its existing combined protection data X′, the target zone initiates a retrieval of a copy of B′ still contained in Source 2 source zone.

In FIG. 3B, in a second process 304, upon receipt of the copy of B′ the target zone performs an XOR operation on X′ and B′ to produce the missing A′.

A′=X′ ⊕ B′ [EQ. 4]

In FIG. 3C, in a third process 306, the reproduced A′ is replicated back to its original source zone, Source 1. In FIG. 3D, in a fourth process 308, upon completion of the recovery of A′, the copies of A′ and B′ are again deleted from the target zone as they are no longer needed because the copies residing on the respective Source 1 and Source 2 zones and the combined chunk residing on the target zone provide sufficient protection.

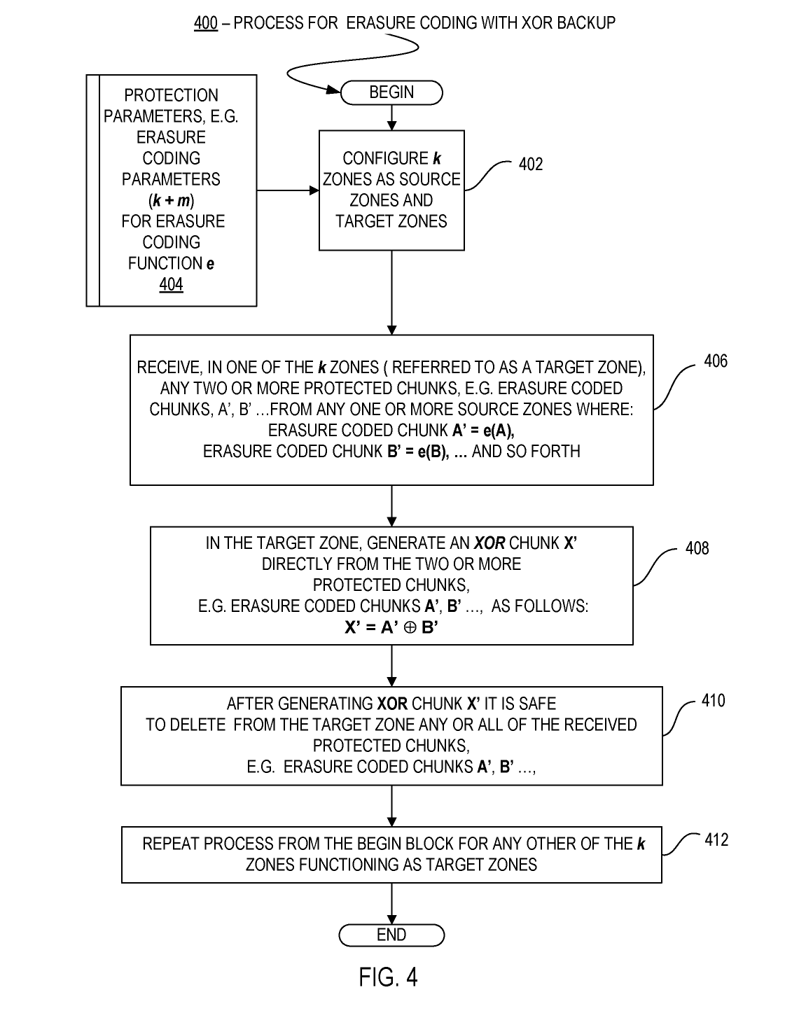

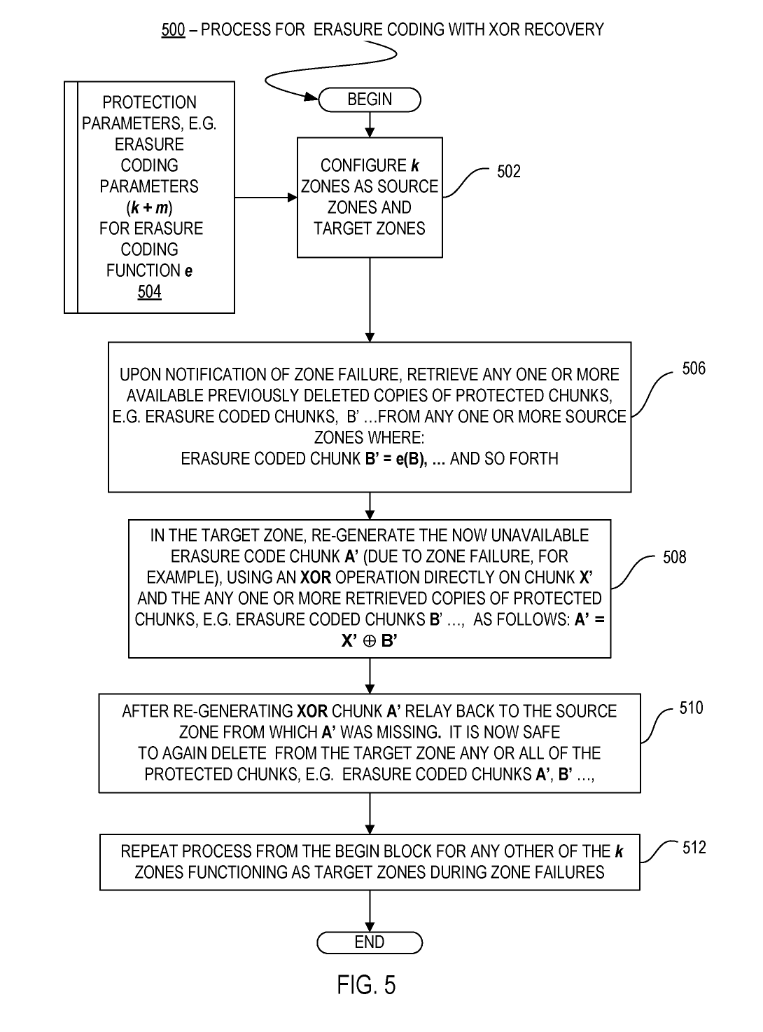

FIGS. 4 and 5 describe the logic of the processes depicted in the examples of the foregoing FIGS. 2A-2C and FIGS. 3A-3D. In FIG. 4, a process 400 for distributed data backup begins at 402, in which a distributed data protection system is configured into zones, such as into source zones and target zones in accordance with protection parameters, including erasure coding parameters 404 for the erasure coding function e. At 406, a target zone receives any two or more chunks of data A′ and B′ from any one or more source zones, where A′ =e(A) and B′=e(B), and so forth.

In one embodiment, at 408 the backup process 400 generates an XOR chunk X′ directly from the two or more protected chunks, e.g. A′ and B′, using formula X′=A′ ⊕ B′ [EQ.3, above]. At 410 the backup process 400 continues by deleting from the target zone any or all of the received protected data chunks, A′, B′, and so forth. At 412, the process 400 is repeated for any other zones in the distributed data storage system that are functioning as target zones.

In FIG. 5, a process 500 for distributed data recovery begins at 502, in which a distributed data protection system was previously configured into zones, such as into source zones and target zones in accordance with protection parameters, including erasure coding parameters 504 for the erasure coding function e. In one embodiment, at process 506, the recovery process 500 receives notification of a zone failure. If needed, the target zone for any unavailable data initiates a retrieval of any one or more of the available previously deleted copies of protected data chunks, e.g. chunk B′, from their respective source zones, where B′=e(B) and so forth. At 508, the recovery process 500 regenerates the now unavailable protected data chunk, e.g. chunk A′. Using an XOR operation A′=X′ ⊕□B′ [EQ. 4] directly on the combined data protection chunk X′ and the retrieved data chunk B′, the recovery process 500 regenerates the missing chunk, chunk A′. At 510, the recovery process 500 relays the re-generated chunk A′ back to its original source zone and again deletes all of the protected chunks A′ and B′ that are again no longer needed on the target zone. At 512, the recovery process 500 is repeated for any other of the zones function as target zones during zone failures.

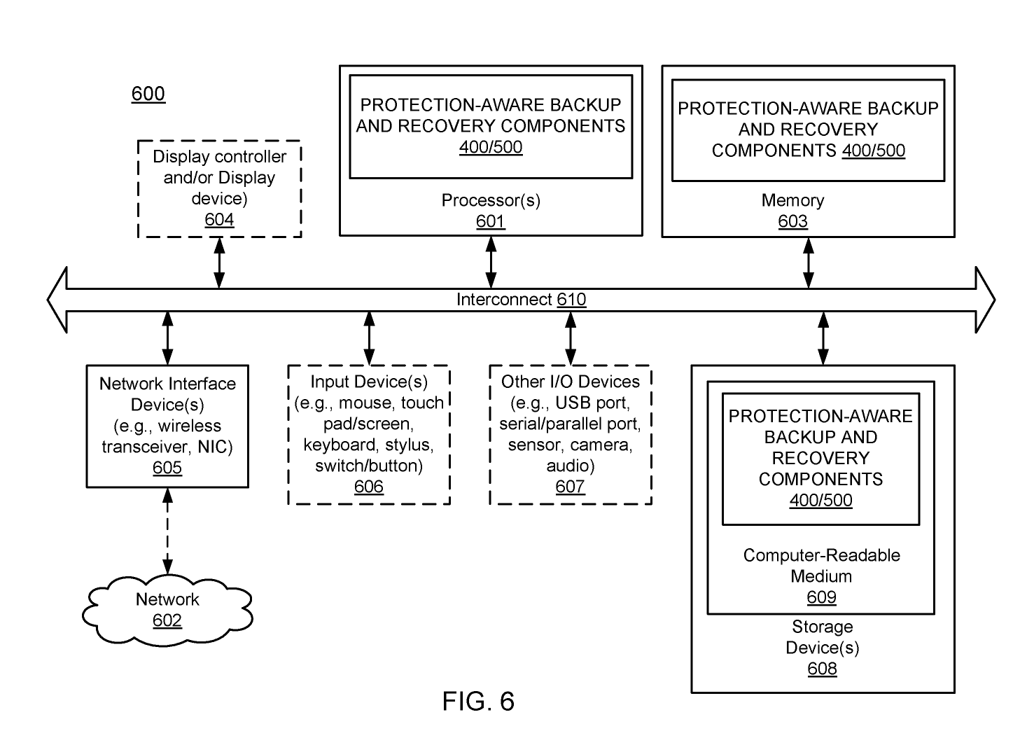

FIG. 6 is a block diagram illustrating an example of a data processing system 600 that may be used with one embodiment of the invention. For example, system 600 represents any of data processing systems described above performing any of the processes or methods described above. System 600 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 600 is intended to show a high level view of many components of the computer system. However, it is to be understood that additional components may be present in certain implementations and furthermore, different arrangement of the components shown may occur in other implementations. System 600 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 600 includes processor 601, memory 603, and devices 605-608 via a bus or an interconnect 610. Processor 601 may represent a single processor or multiple processors with a single processor core or multiple processor cores included therein. Processor 601 may represent one or more general-purpose processors such as a microprocessor, a central processing unit (CPU), or the like. More particularly, processor 601 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 601 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 601, which may be a low power multi-core processor socket such as an ultra-low voltage processor, may act as a main processing unit and central hub for communication with the various components of the system. Such processor can be implemented as a system on chip (SoC). Processor 601 is configured to execute instructions for performing the operations and steps discussed herein. System 600 may further include a graphics interface that communicates with optional graphics subsystem 604, which may include a display controller, a graphics processor, and/or a display device.

Processor 601 may communicate with memory 603, which in one embodiment can be implemented via multiple memory devices to provide for a given amount of system memory. Memory 603 may include one or more volatile storage (or memory) devices such as random access memory (RAM), dynamic RAM (DRAM), synchronous DRAM (SDRAM), static RAM (SRAM), or other types of storage devices. Memory 603 may store information including sequences of instructions that are executed by processor 601, or any other device. For example, executable code and/or data of a variety of operating systems, device drivers, firmware (e.g., input output basic system or BIOS), and/or applications can be loaded in memory 603 and executed by processor 601. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 600 may further include IO devices such as devices 605-608, including network interface device(s) 605, optional input device(s) 606, and other optional IO device(s) 606. Network interface device 605 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 606 may include a mouse, a touch pad, a touch sensitive screen (which may be integrated with display device 604), a pointer device such as a stylus, and/or a keyboard (e.g., physical keyboard or a virtual keyboard displayed as part of a touch sensitive screen). For example, input device 606 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 607 may include an audio device. An audio device may include a speaker and/or a microphone to facilitate voice-enabled functions, such as voice recognition, voice replication, digital recording, and/or telephony functions. Other IO devices 607 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Devices 607 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 610 via a sensor hub (not shown), while other devices such as a keyboard or thermal sensor may be controlled by an embedded controller (not shown), dependent upon the specific configuration or design of system 600.

To provide for persistent storage of information such as data, applications, one or more operating systems and so forth, a mass storage (not shown) may also couple to processor 601. In various embodiments, to enable a thinner and lighter system design as well as to improve system responsiveness, this mass storage may be implemented via a solid state device (SSD). However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 601, e.g., via a serial peripheral interface (SPI). This flash device may provide for non-volatile storage of system software, including a basic input/output software (BIOS) as well as other firmware of the system.

Storage device 608 may include computer-accessible storage medium 609 (also known as a machine-readable storage medium or a computer-readable medium) on which is stored one or more sets of instructions or software (e.g., module, unit, and/or logic of any of the components of data protection 400/500 and/or storage system 100) embodying any one or more of the methodologies or functions described herein. Module/unit/logic 400/500 may also reside, completely or at least partially, within memory 603 and/or within processor 601 during execution thereof by data processing system 600, memory 603 and processor 601 also constituting machine-accessible storage media. Module/unit/logic 400/500 may further be transmitted or received over a network 602 via network interface device 605.

Computer-readable storage medium 609 may also be used to store the some software functionalities described above persistently. While computer-readable storage medium 609 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media, or any other non-transitory machine-readable medium.

Module/unit/logic of the storage system and data protection system components and other features described herein can be implemented as discrete hardware components or integrated in the functionality of hardware components such as ASICS, FPGAs, DSPs or similar devices. In addition, module/unit/logic 400/500 can be implemented as firmware or functional circuitry within hardware devices. Further, module/unit/logic 400/500 can be implemented in any combination hardware devices and software components.

Note that while system 600 is illustrated with various components of a data processing system, it is not intended to represent any particular architecture or manner of interconnecting the components; as such details are not germane to embodiments of the present invention. It will also be appreciated that network computers, handheld computers, mobile phones, servers, and/or other data processing systems that have fewer components or perhaps more components may also be used with embodiments of the invention.

FIG. 7 is a block diagram illustrating exemplary erasure coded data 700 in one possible data layout for providing a data protection system according to one embodiment of the invention. As illustrated a piece of data (D), such as a chunk of protected data, is divided into k data fragments 700. During erasure encoding redundant m coding fragments are created.

The erasure coding is performed to assure that the distributed data protection system can tolerate the loss of any m fragments. In one embodiment, the erasure coding parameter k+m is 12+4, i.e. k equals to 12 and m equals to 4. In this case, there are 16 nodes and 16 fragments to be stored (12+4=16).

In one embodiment, each node of a data storage system such as the one illustrated in FIG. 1, contains just one fragment. A cluster may have fewer nodes, and one node can contain several fragments.

In one embodiment, the data protection embodiments described herein implement a variant of matrix-based Reed-Solomon erasure coding. FIG. 8 is a block diagram illustrating one such exemplary matrix-based erasure coding for k+m=12+4 fragments, and used in providing a data protection system according to one embodiment of the invention.

In the illustrated embodiment in FIG. 8, the k+m data and coding fragments (12+4) are a matrix-vector product, where the vector consists of k (12) data fragments and the matrix is a distribution matrix of (k+m)×k size. The first k rows of the distribution matrix compile a k×k identity matrix. The bottom m rows of the distributed matrix form the coding matrix. Coefficients Xi,j are defined in a variety of ways depending on erasure coding algorithm used.

In one embodiment, during encoding, the distribution matrix is multiplied by a vector and produces a product vector containing both the data and the coding fragments. When some fragments are lost, the fragments are restored using a decoding matrix.

In one embodiment, the illustrated erasure coding scheme is the Reed-Solomon erasure coding scheme based on Galois Field (GF) arithmetic. In a typical embodiment, Galois fields with field's order 2̂w, where w is usually 4, 8, or 16. For such fields an ADD operation can be implemented using a single XOR operation.

In the illustrated erasure coding scheme shown in FIG. 8, the coding matrix from is populated with some numbers from Galois fields (e.g., coefficients Xi,j). In one embodiment, the erasure coding scheme is a bit-matrix erasure coding scheme in which each value from the coding matrix is expanded in a specific way to w×w matrix (e.g. 4×4), where each element is either 0 or 1. Thus, a 4×12 coding matrix is transformed to 16×48 binary coding matrix.

Similarly, a data vector of 12 elements transforms to binary data vector of 48 elements (12×4=48). In the illustrated embodiment, the bit matrix erasure coding using a binary matrix and a vector allows shifting down from a Galois field (2̂w) arithmetic to Galois field (2) arithmetic. For the latter type of arithmetic, a relatively slow multiplication operation performed using a specific multiplication table can be replaced by an extremely fast AND operation.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the invention also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-executable method of data protection, the method comprising:
configuring a distributed storage system into zones, including a target zone and one or more source zones, each zone containing chunks of data subject to replication in which the chunks of data include primary data and protected data, the protected data encoded with a protection operation on the primary data, the protection operation commutative with an exclusive or (XOR) operation;
in the target zone:
combining two or more chunks of protected data with the XOR operation to generate a combined chunk of protected data;
retaining the combined chunk of protected data; and
deleting the two or more chunks of protected data from which the combined chunk of protected data was generated.

2. The computer-executable method of claim 1, further comprising:
in the target zone:
recovering an unavailable chunk of the two or more chunks of protected data from the combined chunk of data, including:
obtaining an available chunk of the two or more chunks of protected data from which the combined chunk of protected data was generated; and
combining the combined chunk of data and the available chunk of data with the XOR operation to recover the unavailable chunk of data.

3. The computer-executable method of claim 2, wherein the available chunk of the two or more chunks of protected data is obtained from a source zone remote from the target zone.

4. The computer-executable method of claim 1, wherein the chunks of data are fixed blocks of data belonging to a set of blocks stored in a partitioned disk space.

5. The computer-executable method of claim 1, wherein the protection operation is an erasure coding encoding function e with parameters k+m, in which k indicates a number of data fragments into which the chunks of data are divided and m indicates a number of redundant coding fragments for recovering from a loss of any m of the k+m data fragments.

6. The computer-executable method of claim 1, wherein the erasure coding encoding function e is a matrix-based erasure coding function, including a Reed-Solomon erasure coding based on Galois Field arithmetic.

7. The computer-executable method of claim 1, wherein the XOR operation is commutative with the erasure coding encoding function e.

8. A computer-executable method of data protection in a distributed storage system, the method comprising:
configuring a distributed storage system into zones, including a target zone and one or more source zones, each zone containing chunks of data subject to replication in which the chunks of data include primary data and protected data, the protected data encoded with a matrix-based erasure coding operation on the primary data, the matrix-based erasure coding operation:
having parameters k+m in which k indicates a number of data fragments of chunk data and m indicates a number of redundant coding fragments for recovering from a loss of any m of the k+m fragments of chunk data, and commutative with an exclusive or (XOR) operation;
in the target zone:
receiving in the target zone from the any one or more source zones at least two chunks of protected data;
combining the at least two chunks of protected data into a single chunk of protected data; and
deleting from the target zone the at least two chunks of protected data from which the single chunk of protected data was combined.

9. The computer-executable method of claim 8, further comprising:
in the target zone:
recovering an unavailable chunk of the deleted chunks of protected data, the unavailable chunk no longer available on any of the zones of the distributed storage system, the recovering including:
obtaining at least one available chunk of the deleted chunks of protected data; and
combining the single chunk and the at least one available chunk with the XOR operation to recover the unavailable chunk of protected data.

10. The computer-executable method of claim 9, wherein the at least one available chunk is obtained from any one or more source zones remote from the target zone.

11. The computer-executable method of claim 8, wherein the chunks of data are fixed blocks of data belonging to a set of blocks stored in a partitioned disk space.

12. The computer-executable method of claim 8, wherein the zones into which the distributed storage system is configured is distributed across a geographical area.

13. The computer-executable method of claim 8, wherein the distributed storage system is a cloud-based storage system accessible over an inter-network.

14. At least one non-transitory computer-readable storage medium having instructions stored therein, which when executed by a processor, cause the processor to perform operations for data protection in a distributed storage system, the operations comprising:
configuring a distributed storage system into zones, including a target zone and one or more source zones, each zone containing chunks of data subject to replication in which the chunks of data include primary data and protected data, the protected data encoded with an erasure coding protection operation on the chunk data, the erasure coding protection operation commutative with an XOR operation;
performing, in the target zone:
combining two or more chunks of protected data with the XOR operation to generate a combined chunk of protected data;
retaining the combined chunk of protected data; and
deleting the two or more chunks of protected data from which the combined chunk of protected data was generated.

15. The at least one non-transitory computer-readable storage medium of claim 14, the operations further comprising:
performing, in the target zone:
recovering an unavailable chunk of the two or more chunks of protected data from the combined chunk of data, including:
obtaining an available chunk of the two or more chunks of protected data from which the combined chunk of protected data was generated; and
combining the combined chunk of data and the available chunk of data with the XOR operation to recover the unavailable chunk of data.

16. The at least one non-transitory computer-readable storage medium of claim 15, wherein the available chunk of the two or more chunks of protected data is obtained from a source zone remote from the target zone.

17. The at least one non-transitory computer-readable storage medium of claim 14, wherein the chunks of data are fixed blocks of data belonging to a set of blocks stored in a partitioned disk space.

18. The at least one non-transitory computer-readable storage medium of claim 14, wherein the erasure coding protection operation is an erasure coding encoding function e with parameters k+m, in which k indicates a number of data fragments into which the chunks of data are divided and m indicates a number of redundant coding fragments for recovering from a loss of any m of the k+m data fragments.

19. The at least one non-transitory computer-readable storage medium of claim 14, wherein the erasure coding encoding function e is a matrix-based erasure coding function, including a Reed-Solomon erasure coding based on Galois Field arithmetic.

20. The at least one non-transitory computer-readable storage medium of claim 14, wherein the XOR operation is commutative with the erasure coding encoding function e.
